(19) United States
(12) Patent Application Publication
(10) Pub. No.: US 2011/0095544 A1
(43) Pub. Date: Apr. 28, 2011

(54) Magnetic Drive Inducing Constant-Speed Rotation

(76) Inventor: Arkadiusz Fijalkowski, Warsaw (PL)

(21) Appl. No.: 12/841,018

(22) Filed: Jul. 21, 2010

(51) Int. Cl. H02K 7/18; H02K 21/00; H02N 11/00

(52) U.S. Cl. 290/1 R; 310/152; 415/916

(57) ABSTRACT

A drive system moved by the power of repelling magnets causes a big wheel to rotate. The big wheel induces the rotation of a smaller wheel, connected to the shaft of an alternator (if we want to obtain obtaining an a.c. current) or a generator (for a c.c. current) which, through a forced rotation, produces electric energy. This is a maximum simple and cheap system which produces alternating current non-stop for many years on end, where it is needed, without fuel or waste.

### CROSS-REFERENCE TO RELATED APPLICATIONS

Not Applicable

### STATEMENT REGARDING FEDERALLY SPONSORED RESEARCH OR DEVELOPMENT

Not Applicable

### GENE SEQUENCES, DIAGRAMS, COMPUTER PROGRAMS

Not Applicable

### BACKGROUND OF THE INVENTION

In response to the increasing demand for cheaper energy, we propose a universal, maximally simplified drive, able to induce rotating movement in elements of diverse machines and devices. The described drive system, which we want to patent, uses the force of repelling magnets' fields (N—see FIG. 6). Together with an alternator or a generator of alternating current, it forms a “home-scale current generator”. From now we will use the word “generator” to point to the whole engine, as the description of the drive alone does not illustrate its possibilities well enough. The principle of its functioning is the change of magnetism into kinetic energy, propelling the shaft, and possibly its change, in turn, into electrical energy.
The kinetic energy generated by our drive creates a pure ecological energy, as it does not need any fuel. As a result, we get an alternating current or a direct current, depending on to which machine the drive is linked, with parameters suitable to the country where it will be employed.

The whole is a mechanical system, simple and cheap, able i. a. to create electric energy, quite such as that in a socket, to supply an average household, directly where it is needed, without costly long-distance transfer.

Many until now had been trying to use magnets in drives, and some good results have been obtained. We can claim that ours is simpler than most.

All the beneath described patents are registered in the USPTO archives. All of them describe a rotatory movement caused by magnets, serving different purposes.

1. U.S. Pat. No. 2,243,555 Faus—27 of May 1941 (a Magnetic Gear)

Magnetized teeth (i.e. made of permanent magnets) with their N poles directed outwardly, attached (various spaces are possible) to the borders of two wheels of different sizes, intermesh loosely so that the adjacent surfaces of the teeth of the two supports have the same polarity. Thus they repel one another, which induces rotation of one of the structures. Variants of the device permit to the teeth of the two gears to stay separated, or—thanks to an additional stationary magnet repulsing at least one gear—to induce a thrust on that gear, or—the device also including a shaft and a worm—to propel the worm by sole repulsing, without direct contact. The device is meant to be used in measuring.

In our (A. F.) invention, the magnets do not protrude from the wheel, and they are the only ones to move, as the external magnet is stationary. The destination of the drive is also different.

2. U.S. Pat. No. 2,378,129 Chambers—12 of Jun. 1941

Two (preferably) annular-shaped magnets are mounted for relative movement on perpendicular axes. The movement is between a position in which resultant of the forces set up by their magnetic fields is in one direction through a neutral (instable) position, and a position in which the resultant is in the opposite direction. One or both magnets shall be movable. The driven magnet has a gap between its poles, through which passes the driving magnet, or else both magnets have such a gap. Means for limiting the rotational movement of the driven magnet are also necessary. The magnets are intended to provide a snap action for use in switches.

We (A. F.) claim not a device used for switching, but one which produces either mechanical work or electrical energy, using bar-shaped magnets.

3. U.S. Pat. No. 2,790,095 Peek and Cluwen—23 of Apr. 1957 (a Mechanical Device)

A device for converting rotary motion in one direction into reciprocating motion (and vice versa—some variants are proposed). A rotating wheel, into which a plurality of permanent axial magnets are mounted, interacts with a second wheel with similarly disposed magnets, prevented from rotation by springs, in such order that the second wheel creates a reciprocating movement of the first. Thus mechanical work (pumping, grinding, polishing . . . ) may be done.

Here, two wheels with built-in magnets are involved instead of one wheel with one external magnets; moreover, no use for an alternator or generator is claimed, as we (A. F.) do.

4. U.S. Pat. No. 2,855,786 Spodig—14 of Oct. 1958

### U.S. Cl. 476/11; 19/272; 74/29; 74/DIG.4

Two permanent magnets are connected at like pole ends to the opposite ends of a spindle member (its form may vary) of magnetizable material. That arrangement. A pair of cup-shaped magnetizable members are attached (at inner faces) to the other like pole ends, respectively, of the permanent magnets. The rims of both cups are of the same polarity that the other pole end of the permanent magnets.

The whole form a magnetic drive, as a driving or a driving part, to be used in meters, couplings, measuring instruments and other devices having rolling or turning movements or functions.

Our (A. F.) magnetic drive comprises only bar magnets, but otherwise no magnetizable structures of any shape. In addition to providing mechanical work, we claim that our invention can be employed to produce electric energy.

5. U.S. Pat. No. 3,879,622 Ecklin—22 of Apr. 1975 (a Mechanical Device)

A pair of permanent magnets are positioned on a common axis; in the space between them, a magnetizable material is mounted, and biased by springs, separated from each magnet by a rotatable shutter, alternatively exposing it to the magnetic fields and shielding it from them. When the magnetizable member is exposed to the magnetic fields, the magnets repel each other and it reciprocates along their common axis. This motion is easily converted into work. In a variant of the device, the permanent magnets are spring-biased and separated only by a magnetic shielding shutter, moved into the space between them and out of it. This permits the magnets to repel each other against the spring action, whereby a reciprocating motion is allowed.

This device includes permanent magnets, but of another configuration—non built in a wheel, as in our (A. F.) invention. It serves only the purpose of doing mechanical work, with no mention of producing electricity.

6. U.S. Pat. No. 3,992,132 Putt—16 of Nov. 1976 (a Mechanical Device)

### U.S. Class 417/271, 417/273, 417/410, 417/420, 310/46, 310/103

A set of primary magnets, all of the same polarity, moving along an endless path (preferably circular) repulses transversally to the path a set of secondary magnets—with poles alternately disposed—linked to them by drive means. Thus the input energy is minimized. The proposed power take-off are fluid pumps connected to each of the secondary magnets; the fluid can be stored under pressure in order to operate a motor. The device may be used in vehicles as means of smoothly and quickly acceleration and braking.

In this invention two sets of magnets are claimed, not a single external magnet and a set of magnets built in a wheel which (A. F.) we propose. The utility is for pumping and breaking, not producing electrical energy.

7. U.S. Pat. No. 4,179,633 Kelly—18 of Dec. 1979 (a Mechanical Device)

### U.S. Cl. 310/80, 310/103

A magnetic wheel drive is propelled into motion by a series of identical magnets, supported by brackets, uniformly oscillating between the wheel's magnets (as in a clock escapement mechanism). The oscillation is induced by a ball bearing motor (or by motors) powered by photovoltaic cells, or else by a magnetic commutator. Reciprocating movement appears and is transmitted to other shafts.

This drive needs to be alimented in energy, unlike in our (A. F.) case.

8. U.S. Pat. No. 4,267,647 C. Anderson Jr, R. Anderson—19 of May 1981 (for School Demonstrations)

### U.S. Cl. 35/19A

On one common shaft, a plurality of rotating discs is placed, with spaces between them, each bearing magnets built in their rims, at equal distances, with one (the same for all) pole turned outwards. Stationary field magnets are disposed with similar poles towards the corresponding poles on each disc, but they are separated by permeable magnetic shields. The magnets on the wheels are first attracted to the field ones, but the periodical removing of the shields causes them to repel each other. The combination of these two interactions cause the rotors to rotate further.

This device is much more complex than our (A. F.) invention, as it comprises more than one disc and more than one external magnet. Its utility is restricted to demonstrations, whereas ours may be used to produce electrical energy or to do work.

9. U.S. Pat. No. 4,629,921 Gavaletz—16 of Dec. 1986 (Dynamoelectric Machine Rotor)

### U.S. Cl. 310/156, 310/261

The rotor consists of a flywheel onto the plane of which an even number of bar magnets are mounted, at equal distances, with their N-poles outwards, and at a 45° angle to its diameter (imagined when passing the center point of the given magnet). Therefore they do not change polarity under demagnetizing conditions. Such a rotor can be used e.g. in a synchronous motor, taking off it much less current than other rotors.

The resemblance to our (A. F.) invention is close. However, a position of the magnets at an a 45° angle to the diameter of the wheel are claimed, whereas our magnets may be inclined in different angles, form 0 to 45°. Then, demagnetizing conditions are involved, which is not our case.

10. U.S. Pat. No. 5,569,967 Rode—29 of Oct. 1996 (Magnetic Gear and Gear Train)

### U.S. Cl. 310/103; 310/83; 74/640; 74/DIG.4

To replace gears with teeth, an arrangement of gears of non-metallic magnetizable members is proposed, the rotatable member having a plurality of magnets along its circumference, the adjacent magnets being inversely aligned, so that alternate poles are spaced along the first axial and the second axial end about the circumference. When a plurality of gears have such an alignment, the magnetic units of adjacent gears attract one another, and rotation is transferred. Here magnetic attraction is used to induce the rotatory movement, and the magnets are disposed on the circumference of the gears. Our (A. F.) drive relies on magnetic repelling, and the magnets involved are attached to the wheel radially.

11. U.S. Pat. No. 5,594,289 Minato—14 of Jan. 1997 (Magnetic Rotating Apparatus).

### U.S. Cl. 310/156, 310/261

On one axis are disposed several wheels with magnets as in [Gavaletz 1986]. The so constructed rotor is equipped with balancers. At one side of the rotor, electromagnets are placed, energized by the rotations of the rotor. Rotational energy is thus obtained, with only a minimum loss for alimenting the electromagnets.

The described apparatus, more complex than our (A. F.) drive, has to be alimented, whereas ours does not need it.

12. U.S. Pat. No. 5,925,958 Pirc—20 of Jul. 1999 (DC Motor Using Permanent Magnets)

### U.S. Cl. 310/152, 310/46, 310/48, 310/112, 310/114, 310/153

A stator spins first about its axis; a second stator interacts with a magnetic field, which permits the creation of enough magnetic force to rotate the stator. On the central axis, a rotor is mounted, with a pair of arcuate magnets close to its periphery, diametrically opposing; when it passes the stator's axis, they are in magnetically attracting mode. The stator is caused to spin on its axis, then, after half the rotor's channel has passed it, then it stops to enter into a magnetically repelling mode. Attraction and repelling are synchronized, and therefore the transfer of magnetic force into mechanical force is possible.

The motor described above transfers electrical energy into magnetism, and that in turn is transferred to mechanical energy. Our (A. F.) drive must not be alimented, and the energy transfer in quite the opposite.

13. U.S. Pat. No. 6,841,909 Six—11 of Jan. 2005 (a Magnetic Drive System)

### Current U.S. Class: 310/103; 310/105

The system consists of a motor-driven assembly, a motor shaft, connected to it, and a coupling member. Two permanent cylindrical magnets at least, disposed in a ring, and an electrically conductive cylinder form the motor shaft; another conductive cylinder is included in the coupling member, in such position that the magnets can interact with it longitudinally. This in turn permits the coupling member's and the machine shaft's rotation in reaction to a rotatory movement of the motor-driven assembly, as well as the coupling of power between these elements.

In a variant of the system, the ring of magnets is in the motor assembly, and the conductive cylinder—in the machine.

The construction and purpose of this drive system is different than ours (A. F.): the magnets are cylindrical or built in cylinders, when all ours are bar magnets, a plurality built in a wheel plus an external one; the whole serves to provide mechanical work, whereas we add to that the production of electricity.

14. U.S. Pat. No. 7,687,956 Wise 30 of Mar. 2010 (a Drive Motor System)

### U.S. Cl. 310/103, 310/112, 310/114

This complex system comprises o torque converter which receives a rotatory movement from a source, and producing rotatory movement in the output. A generator system is coupled to this output, and in turn a motor drive is coupled to the generator. The generator in turn may drive the torque converter.

The converter consists of a body rotatable on an axis, on which body are mounted a plurality of first permanent magnets and a set of third permanent magnets, of a second body with a plurality of second permanent magnets. The first magnets are magnetically coupled to the second magnets, and the second body rotates thanks to the magnetic coupling, and produces the rotational output.

An output control system may be added.

The main differences with our (A. F.) magnetic drive are: in the device patented U.S. Pat. No. 7,687,956, the whole construction may consist even of five main elements; three sets of magnets are used; the magnets built in the first body are of various size (the 1^{st} set vs. the 3^{rd} set). Our invention consist of two or three elements, and we use one set of permanent magnets of the same shape and size, plus one external powerful magnet.

### BRIEF SUMMARY OF THE INVENTION

The inventor aimed not only to obtain a cheap energy source, but also a durable and a easily obtainable one: it means, build of elements commonly used, easy to replace. This implies of course low production costs, and the simplicity of the construction guarantees a long-term use without need to replace the parts often.

No fuel is needed. And the only movement occurring is a rotating one.

We have called the generator a home-scale one, as it can be kept at home: in a cupboard, a closet or a garage for example. The entire energy is produced where it is needed: long and expensive wires for long-distance and high-voltage transmission. It is, moreover, pure, ecological energy, producing no waste (as coal power stations), as no perishable materials are used, and no fuel is burnt to propel the drive.

One more quality: the generator does not make much noise; all we hear during its work is the hissing of the rotating shaft and of the flowing air.

The generator can replace accumulators, as the energy needs not to be stored when the drive is working.

If used directly in the place where energy is needed, it provides close to 100% of the power produced by the machine producing electricity (e.g. an alternator); a loss of some percent may be due to short-distance transfer.

### BRIEF DESCRIPTION OF THE SEVERAL VIEWS OF THE DRAWING

FIG. 1. The Direction of the Magnetization of All the Magnets

FIG. 2. The Way of Magnetization of All the Magnets

FIG. 3. Front View of the Drive together with an Alternator
1. Rubber belt (we chose a cog belt, in order to obtain a better adhesiveness) linking the big wheel to the smaller wheel
2. Magnets, turned with their N pole to the border of the big wheel
3. Attached to the casing, an external magnet, stronger and bigger than the ones in the big wheel, repels them and is repelled in his turn, which propels the big wheel to a rotatory movement
4. Bar supporting the big wheel attached to the alternator
5. Alternator
6. Small wheel, propelling the shaft of the alternator
7. Screws attaching the alternator to its base
8. Wooden base
9. Shaft of the alternator
10. Attachment of the external magnet
11. Big wheel

FIG. 4. Side View of the Drive together with an Alternator
1. Ventilators of the alternator, air outlet
2. Cathode
3. Anode
4. Bar supporting the big wheel attached to the alternator
5. Drive's rubber cog belt
6. Small wheel driving the turning shaft of the alternator
7. Screws attaching the alternator to its base
8. Clip of the casing
9. Attachment of the big external magnet
10. Shaft of the alternator
11. Magnets inside the big wheel

FIG. 5. Inclination of the wheel

The arrow indicates that the inclination of the magnets inserted inside the big wheel may be changed, so that the magnets' fields might interfere on a slighter angle and repel one another more strongly. If ferrite magnets are used, such an arrangement may be a necessity.

FIG. 6:
1. The magnetic field of the external. powerful magnet brushes the field created by the magnets built in the wheel.
2. The wheel shall rotate in this direction
3. If the magnets are incorrectly disposed, the external magnet would repel the others in the direction opposite to the planned one, which means that the big wheel would also rotate in the in the wrong direction, thus disabling the engine. The arrow points to the wrong direction (see FIG. 6, point 3).

FIG. 7. Summary view of the invented drive

1. Big wheel
2. Linking belt (here: a rubber cog belt)
3. Permanent magnets built in the big wheel
4. Small wheel
5. External powerful magnet

### DETAILED DESCRIPTION OF THE INVENTION

The essence of the invention is the drive: a big wheel with built-in magnets, repelled by an exterior magnet, and neither the whole construction—the generator, nor its parts, as the current is actually generated by an alternator (a. c. generator), already invented by Tesla in the end of the XIX century.
The main elements of the generator, i.e. the whole construction, are the following:
   1. A big wheel propelled by repelling magnets, with electric fields opposing each other, in order to cause the rotation of the big wheel. There should be a ball bearing inside the wheel. For smaller wheels a single-row bearing is sufficient; for bigger ones we suggest to use double-row or a roller bearing.
   2. Magnets of any material, the number of which depends on the size of the big (main) wheel. They are very hard, but break easily, that is why they should be placed inside the big wheel (see FIG. 3, element 2 and FIG. 4., el. 11). Anyone with a summary technical knowledge will choose his way of building them in; we do not suggest any technique.
   3. The smaller wheel, linked to the big wheel, and driven by a belt (of any type; we tried a rubber cog belt, which assures a quasi-silent work), rotates the shaft of the alternator; the belt can link the big wheel to a smaller wheel of any kind or to directly to the shaft—see Claim Nr 1. The smaller wheel should rotate five times quicker than the big wheel, that is why its diameter should be about five times smaller. That is a very important point. In order to obtain the voltage of 230 V, required in the countries of the E. U., the smaller wheel should be given a rotation speed of 25 turns a second. This, divided by its diameter, gives 5 turns a second of the big wheel. In order to obtain a voltage as required in the United States, namely 110 V, the diameters should be divided by two, or else the magnets should be smaller/less powerful.

Of course the above proportions apply only when we use the drive to produce electricity. If we use it for mechanical work, it is t the user to establish such proportions of the big wheel and the small wheel as needed.

NB. The rubber driving belt might be linked directly to the shaft, with the exclusion of the small wheel, but this solution provides an inferior adhesiveness. In our embodiment, we used a smaller wheel and a rubber cog belt—this seems more economical.

4. The external, bigger magnet (which we shall call the main magnet), so-called clotted, repelling the magnets attached to the main wheel, should be more powerful that the others. However, this is not imperative in every embodiment. It is attached to the base or the casing of the engine, so that the distance between him and the other magnets might be regulated by hand.

The fifth part is not our invention, but should be described as it provides power. Such an engine has been used when the generator has been tested.

5. An alternator, compared to a c. c. generator, is far more rentable and infallible, as its windings are placed in the stator, not in the rotor, thanks to which there is no need to use a commutator. The alternator is induced, like a c. c. generator, through the windings of the rotor, but it only has one winding wound axially, and elements made of ferromagnetic cause the magnetic field (going through the winding of the stator) to change when the rotator is moving.

During the essays of the drive we used an alternator of 3 kW, which is sufficient for an average household, not using machines that need a bigger power.
Our generator can be used in very low (−30° C.) as well as in very high temperatures (+110° C.). More than +110° C. is not recommended, as the internal elements of the alternator may then clot.

Its weak point is undoubtedly the lack of resistance to higher humidity or to the action of water, common to most of the electric and current generating devices. That is why we recommend to use a casing, with only an air access to cool the engine.
After many tests we established which should be the form and the properties of the magnets used for our generator. This is an essential and, as far as we know, a really innovative point (Claim Nr 1). Namely, they should be elongate and magnetized lengthwise, not across. Such magnets are no more produced today.

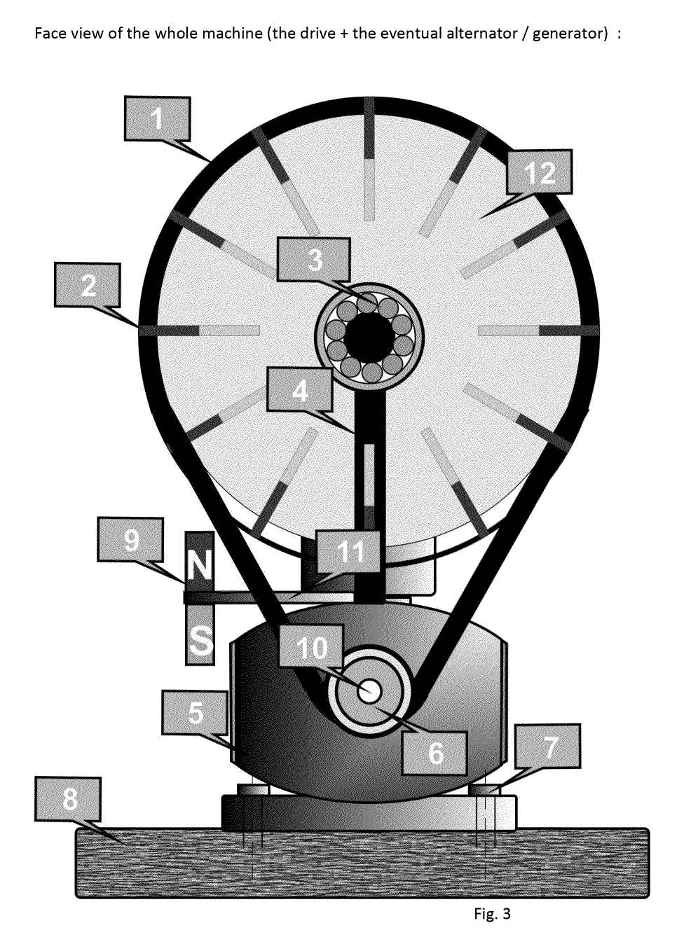

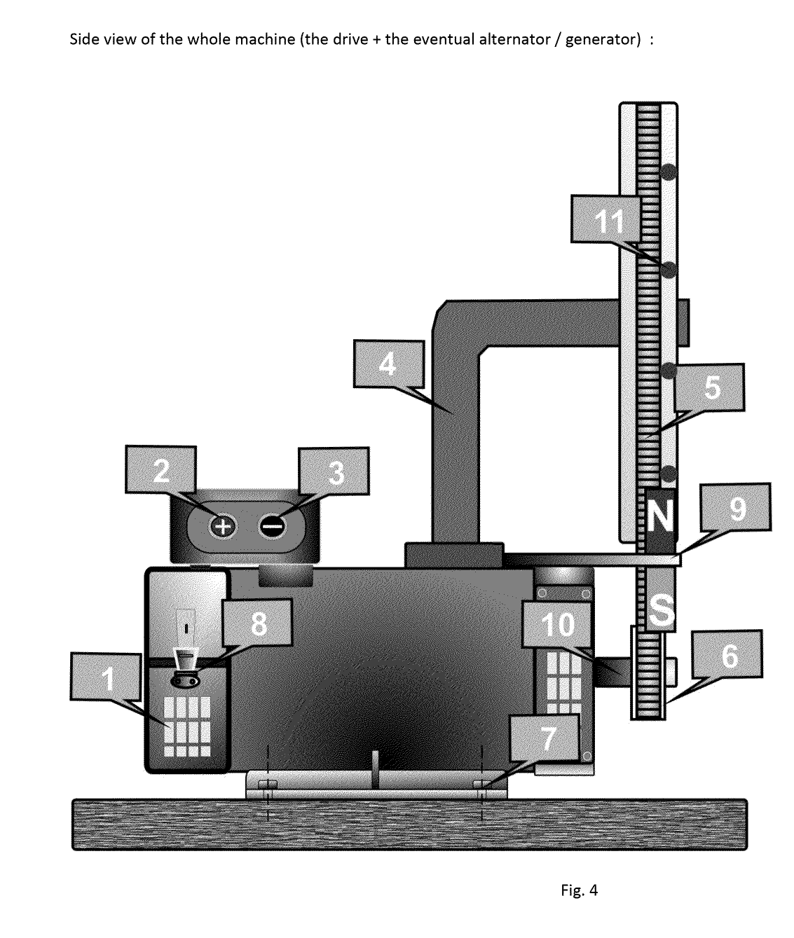

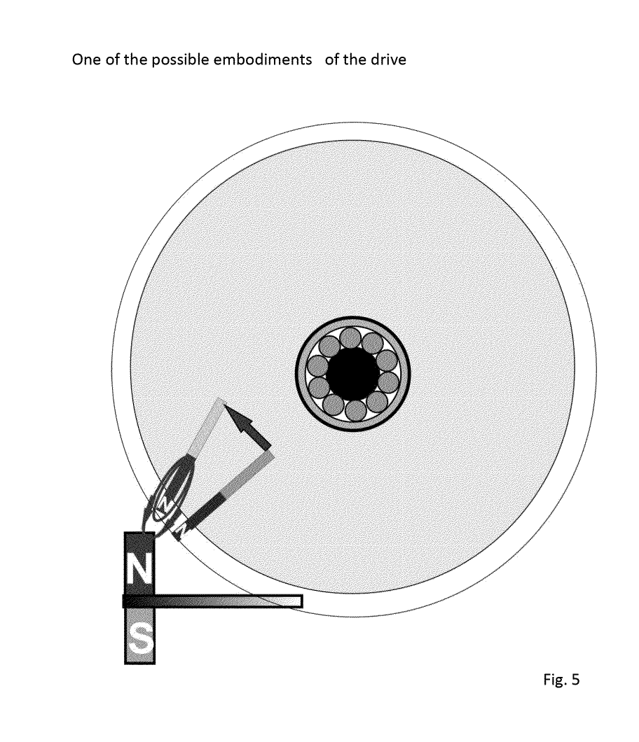

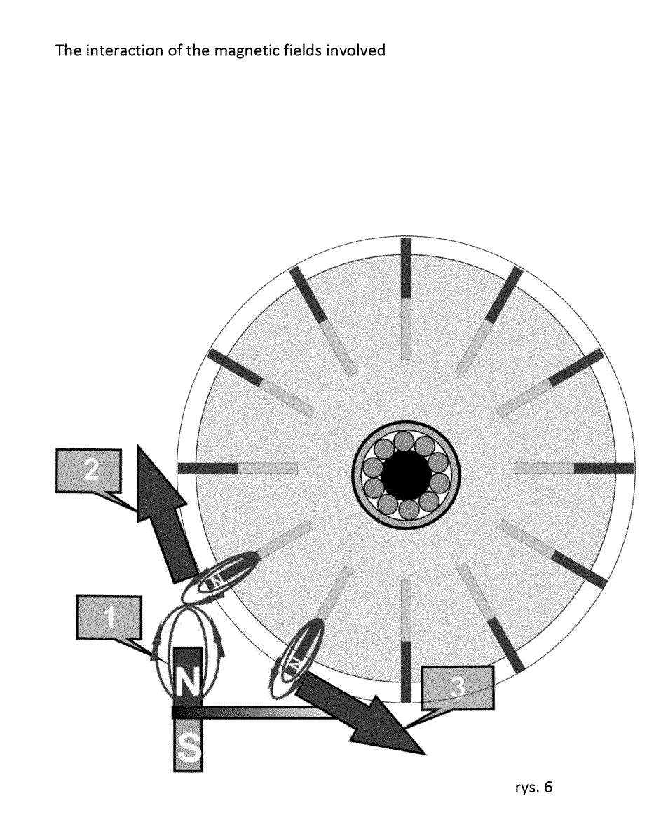

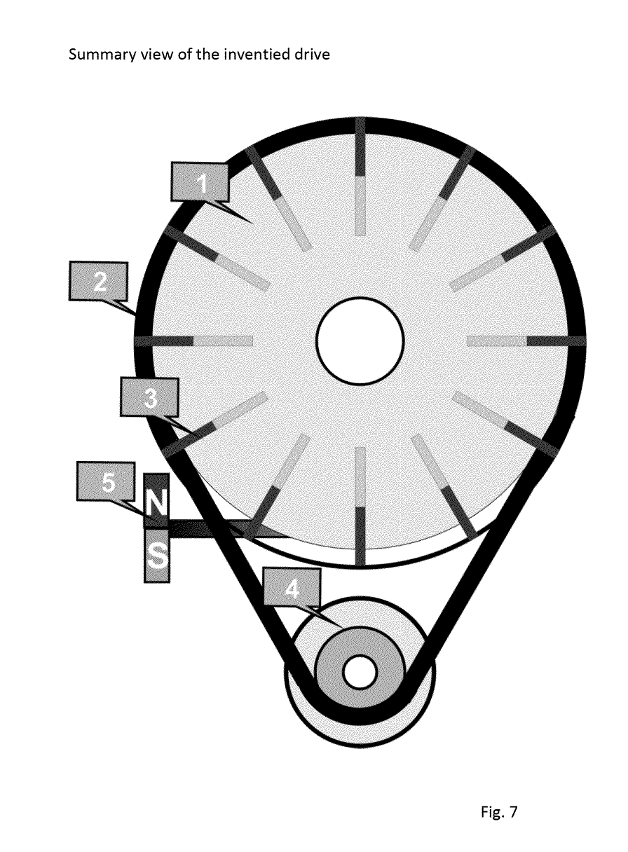

The way of magnetization is shown below (FIG. 2).

Such position of the poles and the elongation of the magnets allow the big wheel to rotate and to work unperturbed. The N and S poles do not superimpose during the rotation, and therefore their magnetic fields are separated from each other. Their shape is important as well; we do not recommend round, conical or pierced ones; they should be quadrangular, or better rectangular, in order to make the repelling magnetic field N stronger, undisturbed by the S field (see FIG. 6).
There is another possibility of changing the force of rotation of the big wheel: the distance between the magnets, i.e. their mutual position. Put closer, they repel one another with more strength, which makes the wheels turn quicker.

But too powerful magnets cannot be used, because in such case the N and S fields will superimpose, and disturb the drive's running (see FIG. 6). That is why the conditions of our drive's work described above are so important.
As to the composition and type of the magnets for this driving system, it is not vital; it is their form and magnetization that matters, to be adjusted by the producer. Their main quality is the so-called eternal magnetization: the first magnets, produced at the turn of the XIX century, have not as yet lost their magnetic properties.

The next essential thing is the drive itself. Low-abrading elements (having a low rotating resistance ratio) should be used.

The wheels should rotate as freely as possible, because of the limited power of the magnets; too big magnets will cause dysfunctions (see FIG. 6).

One of the main features of the engine is that there is no need to start and stop it permanently. The wheel, once started, should continue its rotation until there is a necessity to replace some part, then only it must be stopped.

We aimed i. a. to build such a mechanical device that it might produce an a. c. current, as good as that described by the standards of the Energy Regulation Office (Urzad Regulacji Energetyki). The following parameters are typical for the E. U. countries:

an a.c. current of 230 V, 50-60 Hz—with a margin of the power up to 5% (a margin of no use here, as we can see from the description that the current does not change its power, as the rotatory movement of the drive keeps a constant speed).

The loss of energy in the way to the output stay right within the norm, as the transmission covers a minimal distance. Moreover, the generator is powered in 100% by the magnets, as we did not want to include accumulators or batteries.
The whole engine gets started by approaching the stronger, external magnet (see FIG. 7, el. 1) so that the N poles of the magnets touch, to cause the big wheel to rotate faster and faster, which in turn induces, via the smaller wheel, a sufficient rotation of the shaft to make it produce the desired amount of electric energy.
As the casing gets heated during the work, a free air flow should be assured, in order not to damage the electric elements inside the alternator. No need for additional cooling systems revealed itself during the tests.
All the engine is very safe; to further increase safety, a casing is essential; we did not sketch any model of casing, not to impose our ideas—it just has to leave enough space for the wheels to rotate, the generator/alternator to work, and let the air flow; everyone can opt for such casing or another depending on his needs.

We neither do indicate the exact dimensions nor the chemical components of the embodiment—these, with a minimum of skill in the domain involved, may be chosen appropriately to individual needs.

### Applications.

If really powerful (e.g. neodymium) magnets are used, there can be a need to incline them inside the wheel (FIG. 6, see also Gavaletz (1986)), in order to make the magnetic field repel one another in the right direction. If the rotation of the big wheel is instable, or not constant, because the fields of the magnets inside keep colliding, we can change not only the distance from the external, strong magnet to the others, but also its inclining angle (see above).

### Prospective Use of the Invented Drive.

No one has to be convinced that the electric energy is needed basically everywhere. It would be useless to mention all the situation, but we shall give some examples.
This model is given here in a macro-scale; its use in small-scale can also be tested, in order to accommodate it for torches, mobile phones, electric cars, and in mega-scale for boats and aircrafts.
If it were to be used e.g. in a factory, or somewhere else where much more energy than average is needed, we suggest rather more magnetic generators than one of extended dimensions.
Magnets are also used on board of spaceships, but for other purposes, because they do not lose their magnetic properties in the conditions of weightlessness. The drive we describe may work even better in the Cosmos, as the elements (inside the bears) abrade in a far longer time that on the Earth. Moreover, a magnetic drive eliminates the need for fuel transporting.

1. Magnetic drive—to transform the energy of repelling magnets into kinetic energy, and possibly further into electricity (through an alternator or a generator),
which drive is composed of the following parts:
a big wheel, positioned on a axis, made of a non-magnetic material, at best light (not to impede rotation), in which magnets are built, disposed at equal distances, with their N poles directed to the border of the wheel (their longer dimension may be perpendicular to the tangential of the border, or inclined—deviated from that perpendicular line),
a smaller wheel, of a similar material, connected permanently to the big wheel (e.g. with a rubber belt), and at the same time to the shaft of a machine producing electricity (e.g. an alternator, or a generator), or to a shaft of a mechanical device, so that the constant rotating of the big wheel, caused by the action of repelling magnets, induces constant rotating of the small wheel (with a speed increased according to the reciprocal of the diameter), which in turn activates, respectively, the mechanical device or the machine producing electricity.
a powerful magnet, external to the big wheel, attached to the casing, the N pole of which is directed to the N poles of the built in magnets, i.e. towards the border of the big wheel,
a casing, to which the powerful magnet is attached;

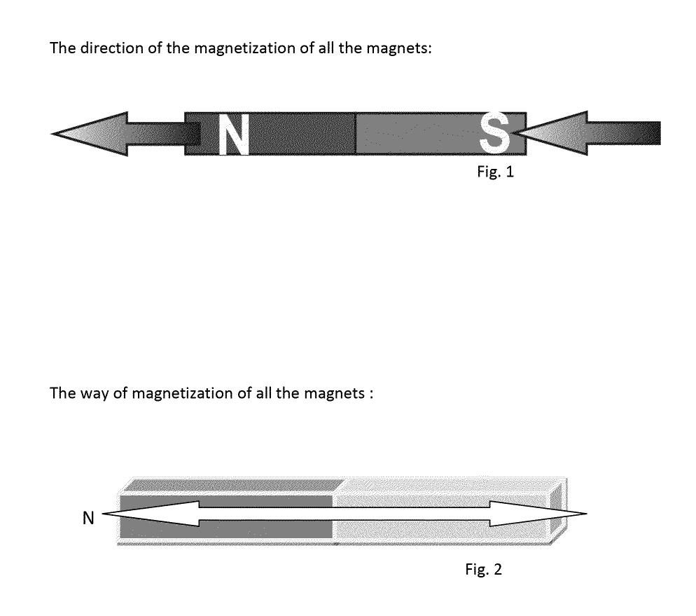

2. The above mentioned magnets built in the big wheel are elongate and magnetized axially (as shown in FIG. 1 and FIG. 2);

3. The above mentioned external magnet is turned with its N pole towards the N poles of the magnets built in the big wheel.
